(19) United States
(12) Patent Application Publication
(10) Pub. No.: US 2016/0341289 A1
(43) Pub. Date: Nov. 24, 2016

(54) MULTI-SPEED TRANSMISSION

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Takayoshi Kato, Handa (JP); Takashi Morimoto, Gamagori (JP); Toshihiko Aoki, Anjo (JP); Hiroshi Kato, Kariya (JP); Satoru Kasuya, Nishio (JP); Terufumi Miyazaki, Toyota (JP); Masaru Morise, Nukata (JP); Shinji Oita, Toyota (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 15/104,450

(22) PCT Filed: Jan. 13, 2015
(86) PCT No.: PCT/JP2015/050632

§ 371 Date: Jun. 14, 2016

(30) Foreign Application Priority Data
Jan. 14, 2014 (JP) 2014-004053

(51) Int. Cl. F16H 3/66

(52) U.S. Cl. CPC F16H 3/666; F16H 3/66; F16H 2200/0008; F16H 2200/0065; F16H 2200/0069; F16H 2200/2012; F16H 2200/2046

(57) ABSTRACT

An automatic transmission includes a single-pinion first planetary gear, a double-pinion second planetary gear, a single-pinion third planetary gear, a single-pinion fourth planetary gear, clutches C1, C2, C3, and C4, and brakes B1 and B2. First to ninth forward speeds and a reverse speed are established by engaging three of the clutches C1 to C4 and the brakes B1 and B2 and disengaging the remaining three clutches and brakes.

### I. TECHNICAL FIELD

Preferred embodiments relate to a multi-speed transmission that transfers power, which has been transferred from a motor of a vehicle to an input member, to an output member with the speed of the power changed.

### BACKGROUND ART

There has hitherto been known a multi-speed transmission that includes four single-pinion planetary gears, four clutches, and two brakes and that provides forward speeds from a first speed to a ninth speed and a reverse speed (see Patent Document 1, for example). With such a multi-speed transmission, the power transfer efficiency, that is, the fuel efficiency of a vehicle on which the multi-speed transmission is mounted, and the drivability, that is, the acceleration performance of the vehicle, can be improved as the spread (gear ratio width=the gear ratio of the lowest speed/the gear ratio of the highest speed) is increased.

### RELATED-ART DOCUMENTS

### Patent Documents

[Patent Document 1] United States Patent Application Publication No. 2012/0165153

### II. SUMMARY

In the multi-speed transmission described in Patent Document 1, however, the gear ratio of the lowest speed is 4.477, the gear ratio of the highest speed is 0.640, and the spread is 6.995. Thus, the multi-speed transmission described in the document still has room for improvement in terms of improving the fuel efficiency and the drivability of the vehicle. In the multi-speed transmission described in Patent Document 1, in addition, the torque distribution of a clutch corresponding to a carrier of a second planetary gear is large (approximately 3.5 times), and the torque distribution ratios (largest value/smallest value of torque distribution) of the clutch and a brake corresponding to the carrier of the second planetary gear are also high (approximately 12 times for the clutch, and approximately 13 times for the brake). Therefore, in the multi-speed transmission described in Patent Document 1, it is necessary to secure the torque capacity by increasing the axial length or the outside diameter of the clutch, which may incur an increase in size and weight of the entire device and degradation in drag loss in the clutch. Further, the controllability (hydraulic controllability) of the clutch and the brake with high torque distribution ratios may be degraded, which may lower the speed change performance.

It is therefore a main object of some preferred embodiments to improve the fuel efficiency, the drivability, and the speed change performance of a vehicle on which a multi-speed transmission is mounted, and to make the multi-speed transmission lightweight and compact.

A preferred embodiment provides a multi-speed transmission that changes a speed of power transferred to an input member to transfer the power to an output member, including: a first planetary gear that has a first rotary element, a second rotary element, and a third rotary element that are arranged sequentially in accordance with a gear ratio; a second planetary gear that has a fourth rotary element, a fifth rotary element, and a sixth rotary element that are arranged sequentially in accordance with a gear ratio; a third planetary gear that has a seventh rotary element, an eighth rotary element, and a ninth rotary element that are arranged sequentially in accordance with a gear ratio; a fourth planetary gear that has a tenth rotary element, an eleventh rotary element, and a twelfth rotary element that are arranged sequentially in accordance with a gear ratio; and first, second, third, fourth, fifth, and sixth engagement elements that connect and disconnect one of the rotary elements of the first, second, third, and fourth planetary gears to and from another rotary element or a stationary member, in which: the second rotary element of the first planetary gear is always coupled to the output member; the first rotary element of the first planetary gear and the tenth rotary element of the fourth planetary gear are always coupled to each other; the third rotary element of the first planetary gear and the ninth rotary element of the third planetary gear are always coupled to each other; the fourth rotary element of the second planetary gear is always coupled to the stationary member; the fifth rotary element of the second planetary gear and the twelfth rotary element of the fourth planetary gear are always coupled to each other; the sixth rotary element of the second planetary gear and the seventh rotary element of the third planetary gear are always coupled to each other; the first engagement element connects and disconnects the first rotary element of the first planetary gear and the tenth rotary element of the fourth planetary gear, which are always coupled to each other, and the input member to and from each other; the second engagement element connects and disconnects the third rotary element of the first planetary gear and the ninth rotary element of the third planetary gear, which are always coupled to each other, and the eleventh rotary element of the fourth planetary gear to and from each other; the third engagement element connects and disconnects the eighth rotary element of the third planetary gear and the eleventh rotary element of the fourth planetary gear to and from each other; the fourth engagement element connects and disconnects the eleventh rotary element of the fourth planetary gear and the input member to and from each other; the fifth engagement element connects the fifth rotary element or the sixth rotary element of the second planetary gear to the stationary member to unrotatably hold the fifth rotary element or the sixth rotary element, and disconnects the fifth rotary element or the sixth rotary element and the stationary member from each other; and the sixth engagement element connects the eighth rotary element of the third planetary gear to the stationary member to unrotatably hold the eighth rotary element, and disconnects the eighth rotary element and the stationary member from each other.

With the thus configured multi-speed transmission, first to ninth forward speeds, or first to tenth forward speeds, and a reverse speed can be established by selectively engaging three of the first, second, third, fourth, fifth, and sixth engagement elements. Consequently, it is possible to improve the fuel efficiency of the vehicle on which the multi-speed transmission is mounted by increasing the spread, and to further improve the drivability, that is, the acceleration performance of the vehicle etc., by making the speed ratios of lower speeds higher and making the speed ratios of higher speeds lower. With the multi-speed transmission, in addition, the torque distribution of each of the first to fourth engagement elements can be reduced to make the first to fourth engagement elements lightweight and compact, and to suppress degradation in drag loss in the first to fourth engagement elements. Further, it is possible to improve the controllability of the first to sixth engagement elements by making the torque distribution ratios of the first to sixth engagement elements lower. Thus, with the multi-speed transmission according to some preferred embodiments, it is possible to further improve the fuel efficiency, the drivability, and the speed change performance of the vehicle on which the multi-speed transmission is mounted, and to make the entire device lightweight and compact.

### BRIEF DESCRIPTION OF THE DRAWINGS

FIG. 1 is a diagram illustrating a schematic configuration of a power transfer device that includes a multi-speed transmission according to an embodiment.

FIG. 2 is a velocity diagram illustrating the ratio of the rotational speed of each rotary element to an input rotational speed of the multi-speed transmission of FIG. 1.

FIG. 3 is an operation table illustrating the relationship between shift speeds of the multi-speed transmission of FIG. 1 and the respective operating states of clutches and brakes.

FIG. 4 is a diagram illustrating a schematic configuration of a power transfer device that includes a multi-speed transmission according to another embodiment.

FIG. 5 is a diagram illustrating a schematic configuration of a power transfer device that includes a multi-speed transmission according to still another embodiment.

FIG. 6 is a diagram illustrating a schematic configuration of a power transfer device that includes a multi-speed transmission according to another embodiment.

FIG. 7 is a diagram illustrating a schematic configuration of a power transfer device that includes a multi-speed transmission according to still another embodiment.

FIG. 8 is an operation table illustrating the relationship between shift speeds of the multi-speed transmission of FIG. 7 and the respective operating states of clutches and brakes.

FIG. 9 is a velocity diagram illustrating the ratio of the rotational speed of each rotary element to an input rotational speed of the multi-speed transmission of FIG. 7.

### MODES FOR CARRYING OUT THE DESCRIPTION

Now, an embodiment will be described with reference to the drawings.

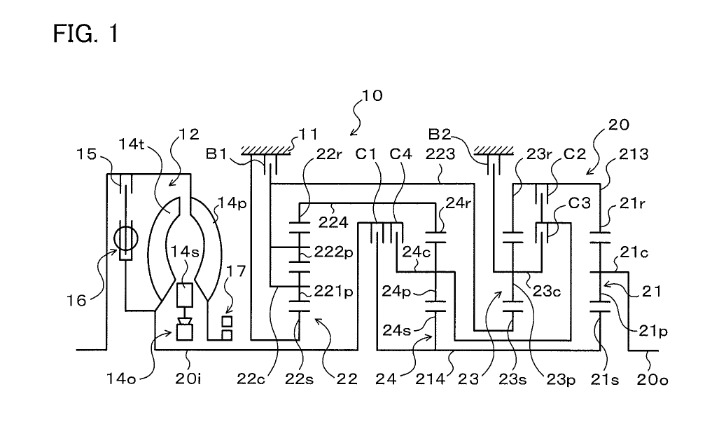

FIG. 1 illustrates a schematic configuration of a power transfer device 10 that includes an automatic transmission 20 that serves as a multi-speed transmission according to an embodiment. The power transfer device 10 illustrated in the drawing is connected to a crankshaft of an engine (internal combustion engine; not illustrated) that serves as a drive source longitudinally mounted in the front portion of a rear-drive vehicle, and can transfer power (torque) from the engine to left and right rear wheels (drive wheels; not illustrated). As illustrated in the drawing, the power transfer device 10 includes a transmission case (stationary member) 11, a starting device (fluid transmission apparatus) 12, an oil pump 17, and so forth in addition to the automatic transmission 20 which transfers power, which has been transferred from the engine to an input shaft 20i, to an output shaft 20o with the speed of the power changed.

The starting device 12 includes a torque converter that has: a pump impeller 14p on the input side coupled to the drive source discussed above; a turbine runner 14t on the output side coupled to the input shaft (input member) 20i of the automatic transmission 20; a stator 14s disposed on the inner side of the pump impeller 14p and the turbine runner 14t to rectify a flow of working oil from the turbine runner 14t to the pump impeller 14p; a one-way clutch 14o that is supported by a stator shaft (not illustrated) and that restricts the rotational direction of the stator 14s to one direction; and so forth. Further, the starting device 12 has: a lock-up clutch 15 that connects and disconnects a front cover coupled to the crankshaft of the engine or the like and the input shaft 20i of the automatic transmission 20 to and from each other; and a damper mechanism 16 that damps vibration between the front cover and the input shaft 20i of the automatic transmission 20. The starting device 12 may include a fluid coupling that does not have the stator 14s.

The oil pump 17 is constituted as a gear pump that has: a pump assembly that includes a pump body and a pump cover; an externally toothed gear (inner rotor) coupled to the pump impeller 14p of the starting device 12; an internally toothed gear (outer rotor) meshed with the externally toothed gear; and so forth. The oil pump 17 is driven by power from the engine to suction working oil (ATF) reserved in an oil pan (not illustrated) and pump the working oil to a hydraulic control device (not illustrated).

The automatic transmission 20 is constituted as a 9-speed transmission. As illustrated in FIG. 1, the automatic transmission 20 includes, in addition to the input shaft 20i: the output shaft (output member) 20o which is coupled to the left and right rear wheels via a differential gear and a drive shaft (not illustrated); and a single-pinion first planetary gear 21, a double-pinion second planetary gear 22, a single-pinion third planetary gear 23, and a single-pinion fourth planetary gear 24 disposed side by side in the axial direction of the automatic transmission 20 (the input shaft 20i and the output shaft 20o). Further, the automatic transmission 20 includes a clutch C1 (first clutch) that serves as a first engagement element, a clutch C2 (second clutch) that serves as a second engagement element, a clutch C3 (third clutch) that serves as a third engagement element, a clutch C4 (fourth clutch) that serves as a fourth engagement element, a brake B1 (first brake) that serves as a fifth engagement element, and a brake B2 (second brake) that serves as a sixth engagement element, the clutches C1 to C4 and the brakes B1 and B2 being used to change a power transfer path from the input shaft 20i to the output shaft 20o.

In the embodiment, the first to fourth planetary gears 21 to 24 are disposed in the transmission case 11 so as to be arranged in the order of the second planetary gear 22, the fourth planetary gear 24, the third planetary gear 23, and the first planetary gear 21 from the starting device 12 side, that is, the engine side (the left side in FIG. 1).

The first planetary gear 21 has: a first sun gear 21s which is an externally toothed gear; a first ring gear 21r which is an internally toothed gear disposed concentrically with the first sun gear 21s; a plurality of first pinion gears 21p meshed with the first sun gear 21s and the first ring gear 21r; and a first carrier 21c that rotatably (turnably) and revolvably holds the plurality of first pinion gears 21p. In the embodiment, a gear ratio λ1 of the first planetary gear 21 (the number of teeth of the first sun gear 21s/the number of teeth of the first ring gear 21r) is determined as λ1=0.280, for example.

The second planetary gear 22 has: a second sun gear 22s which is an externally toothed gear; a second ring gear 22r which is an internally toothed gear disposed concentrically with the second sun gear 22s; a plurality of pinion gears 221p meshed with the second sun gear 22s; a plurality of pinion gears 222p meshed with the respective pinion gears 221p and the second ring gear 22r; and a second carrier 22c that rotatably and revolvably holds the sets of pinion gears 221p and 222p. In the embodiment, a gear ratio λ2 of the second planetary gear 22 (the number of teeth of the second sun gear 22s/the number of teeth of the second ring gear 22r) is determined as λ2=0.435, for example.

The third planetary gear 23 has: a third sun gear 23s which is an externally toothed gear; a third ring gear 23r which is an internally toothed gear disposed concentrically with the third sun gear 23s; a plurality of third pinion gears 23p meshed with the third sun gear 23s and the third ring gear 23r; and a third carrier 23c that rotatably (turnably) and revolvably holds the plurality of third pinion gears 23p. In the embodiment, a gear ratio λ3 of the third planetary gear 23 (the number of teeth of the third sun gear 23s/the number of teeth of the third ring gear 23r) is determined as λ3=0.410, for example.

The fourth planetary gear 24 has: a fourth sun gear 24s which is an externally toothed gear; a fourth ring gear 24r which is an internally toothed gear disposed concentrically with the fourth sun gear 24s; a plurality of fourth pinion gears 24p meshed with the fourth sun gear 24s and the fourth ring gear 24r; and a fourth carrier 24c that rotatably (turnably) and revolvably holds the plurality of fourth pinion gears 24p. In the embodiment, a gear ratio λ4 of the fourth planetary gear 24 (the number of teeth of the fourth sun gear 24s/the number of teeth of the fourth ring gear 24r) is determined as λ4=0.460, for example.

As illustrated in FIG. 1, the first carrier 21c of the first planetary gear 21 is always coupled (fixed) to the output shaft 20o of the automatic transmission 20. In addition, the first sun gear 21s of the first planetary gear 21 and the fourth sun gear 24s of the fourth planetary gear 24 are always coupled to each other via a coupling member (first coupling element) 214, and always rotated and stopped together (and coaxially) with each other. Further, the first ring gear 21r of the first planetary gear 21 and the third ring gear 23r of the third planetary gear 23 are always coupled to each other via a coupling member (second coupling element) 213, and always rotated and stopped together (and coaxially) with each other. In addition, the second carrier 22c of the second planetary gear 22 and the third sun gear 23s of the third planetary gear 23 are always coupled to each other via a coupling member (third coupling element) 223, and always rotated and stopped together (and coaxially) with each other. Further, the second ring gear 22r of the second planetary gear 22 and the fourth ring gear 24r of the fourth planetary gear 24 are always coupled to each other via a coupling member (fourth coupling element) 224, and always rotated and stopped together (and coaxially) with each other. Furthermore, the second sun gear 22s of the second planetary gear 22 is always connected (fixed) to the transmission case 11 which serves as a stationary member, and always stationary.

The clutch C1 connects and disconnects the first sun gear 21s of the first planetary gear 21 and the fourth sun gear 24s of the fourth planetary gear 24, which are always coupled to each other, and the input shaft 20i to and from each other. The clutch C2 connects and disconnects the first ring gear 21r of the first planetary gear 21 and the third ring gear 23r of the third planetary gear 23 (coupling member 213), which are always coupled to each other, and the fourth carrier 24c of the fourth planetary gear 24 to and from each other. The clutch C3 connects and disconnects the third carrier 23c of the third planetary gear 23 and the fourth carrier 24c of the fourth planetary gear 24 to and from each other. The clutch C4 connects and disconnects the fourth carrier 24c of the fourth planetary gear 24 and the input shaft 20i to and from each other. The clutches C1 and C4 are disposed between the starting device 12 and the fourth planetary gear 24, for example. The clutches C2 and C3 are disposed between the first planetary gear 21 and the fourth planetary gear 24, for example.

The brake B1 holds (connects) the second carrier 22c, which is a fixable element of the second planetary gear 22, and the third sun gear 23s, which is a fixable element of the third planetary gear 23, stationary to the transmission case 11, which serves as a stationary member, such that the second carrier 22c and the third sun gear 23s are unrotatable, and releases the second carrier 22c and the third sun gear 23s held stationary from the transmission case 11 such that the second carrier 22c and the third sun gear 23s are rotatable. The brake B2 holds (connects) the third carrier 23c, which is a fixable element of the third planetary gear 23, stationary to the transmission case 11 such that the third carrier 23c is unrotatable, and releases the third carrier 23c held stationary from the transmission case 11, which serves as a stationary member, such that the third carrier 23c is rotatable. The brake B1 is disposed between the starting device 12 and the fourth planetary gear 24, for example. The brake B2 is disposed between the first planetary gear 21 and the fourth planetary gear 24, for example.

In the embodiment, a multi-plate friction-type hydraulic clutch (friction engagement element) is adopted as the clutches C1 to C4. The multi-plate friction-type hydraulic clutch has a piston, a plurality of friction engagement plates (e.g. a friction plate constituted by affixing a friction material to both surfaces of an annular member, and a separator plate which is an annular member with both surfaces formed to be smooth), and a hydraulic servo constituted of an engagement oil chamber, a centrifugal hydraulic pressure cancellation chamber, etc. to which working oil is supplied. Meanwhile, a multi-plate friction-type hydraulic brake is adopted as the brakes B1 and B2. The multi-plate friction-type hydraulic brake has a piston, a plurality of friction engagement plates (a friction plate and a separator plate), and a hydraulic servo constituted of an engagement oil chamber etc. to which working oil is supplied. The clutches C1 to C4 and the brakes B1 and B2 operate with working oil supplied thereto and discharged therefrom by the hydraulic control device (not illustrated).

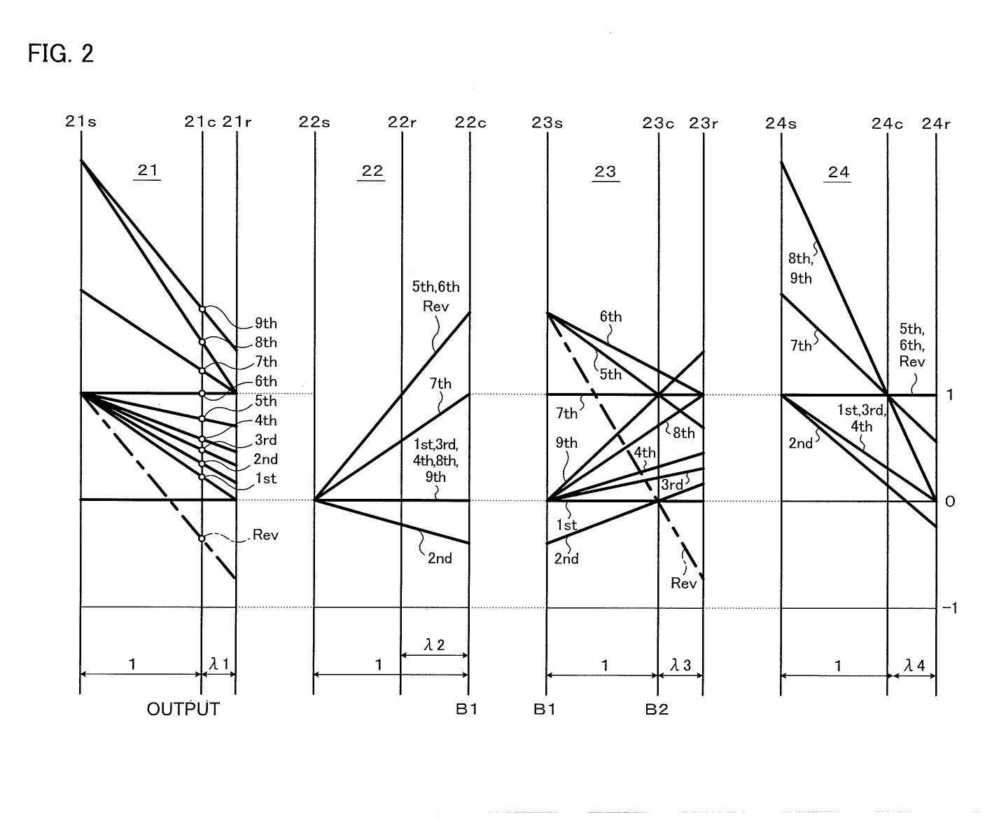

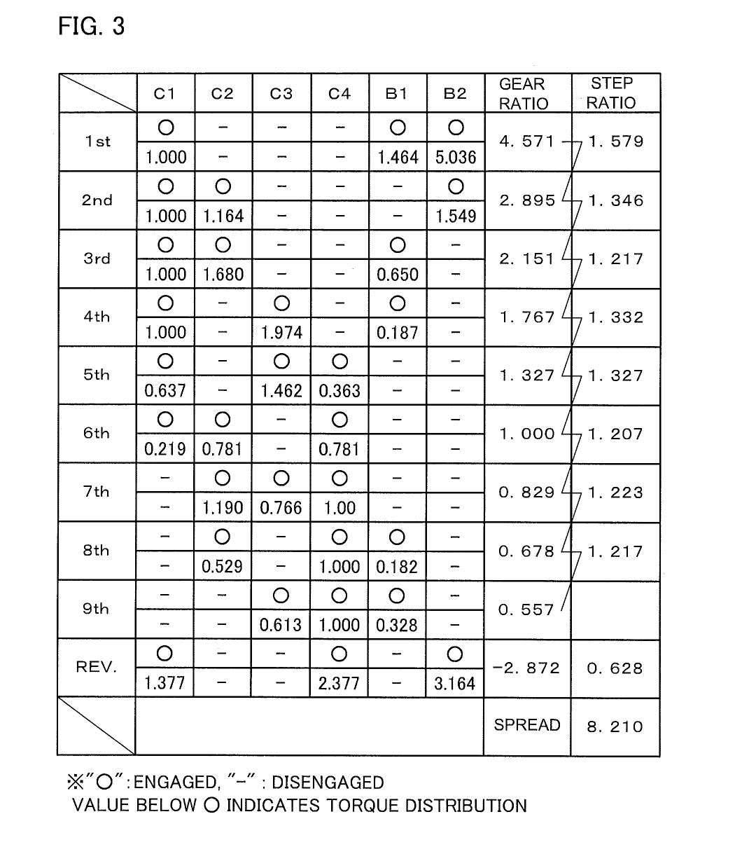

FIG. 2 is a velocity diagram illustrating the ratio of the rotational speed of each rotary element to the rotational speed of the input shaft 20i (input rotational speed) of the automatic transmission 20 (note that the rotational speed of the input shaft 20i is defined as a value of 1; the same applies hereinafter). In addition, FIG. 3 is an operation table illustrating the relationship between shift speeds of the automatic transmission 20 and the respective operating states of the clutches C1 to C4 and the brakes B1 and B2.

As illustrated in FIG. 2, the three rotary elements which constitute the single-pinion first planetary gear 21, that is, the first sun gear 21s, the first ring gear 21r, and the first carrier 21c, are arranged, on the velocity diagram for the first planetary gear 21 (the leftmost velocity diagram in FIG. 2), in the order of the first sun gear 21s, the first carrier 21c, and the first ring gear 21r from the left side of the drawing at intervals that match the gear ratio λ1. In the embodiment, according to the order of arrangement on the velocity diagram, the first sun gear 21s is defined as the first rotary element of the automatic transmission 20, the first carrier 21c is defined as the second rotary element of the automatic transmission 20, and the first ring gear 21r is defined as the third rotary element of the automatic transmission 20. Thus, the first planetary gear 21 has the first rotary element, the second rotary element, and the third rotary element of the automatic transmission 20 which are arranged sequentially in accordance with the gear ratio λ1.

In addition, the three rotary elements which constitute the double-pinion second planetary gear 22, that is, the second sun gear 22s, the second ring gear 22r, and the second carrier 22c, are arranged, on the velocity diagram for the second planetary gear 22 (the velocity diagram that is the second from the left in FIG. 2), in the order of the second sun gear 22s, the second ring gear 22r, and the second carrier 22c from the left side of the drawing at intervals that match the gear ratio λ2. In the embodiment, according to the order of arrangement on the velocity diagram, the second sun gear 22s is defined as the fourth rotary element of the automatic transmission 20, the second ring gear 22r is defined as the fifth rotary element of the automatic transmission 20, and the second carrier 22c is defined as the sixth rotary element of the automatic transmission 20. Thus, the second planetary gear 22 has the fourth rotary element, the fifth rotary element, and the sixth rotary element of the automatic transmission 20 which are arranged sequentially in accordance with the gear ratio λ2.

Further, the three rotary elements which constitute the single-pinion third planetary gear 23, that is, the third sun gear 23s, the third ring gear 23r, and the third carrier 23c, are arranged, on the velocity diagram for the third planetary gear 23 (the velocity diagram that is the second from the right in FIG. 2), in the order of the third sun gear 23s, the third carrier 23c, and the third ring gear 23r from the left side of the drawing at intervals that match the gear ratio λ3. In the embodiment, according to the order of arrangement on the velocity diagram, the third sun gear 23s is defined as the seventh rotary element of the automatic transmission 20, the third carrier 23c is defined as the eighth rotary element of the automatic transmission 20, and the third ring gear 23r is defined as the ninth rotary element of the automatic transmission 20. Thus, the third planetary gear 23 has the seventh rotary element, the eighth rotary element, and the ninth rotary element of the automatic transmission 20 which are arranged sequentially at intervals in accordance with the gear ratio λ3.

In addition, the three rotary elements which constitute the single-pinion fourth planetary gear 24, that is, the fourth sun gear 24s, the fourth ring gear 24r, and the fourth carrier 24c, are arranged, on the velocity diagram for the fourth planetary gear 24 (the rightmost velocity diagram in FIG. 2), in the order of the fourth sun gear 24s, the fourth carrier 24c, and the fourth ring gear 24r from the left side of the drawing at intervals that match the gear ratio λ4. In the embodiment, according to the order of arrangement on the velocity diagram, the fourth sun gear 24s is defined as the tenth rotary element of the automatic transmission 20, the fourth carrier 24c is defined as the eleventh rotary element of the automatic transmission 20, and the fourth ring gear 24r is defined as the twelfth rotary element of the automatic transmission 20. Thus, the fourth planetary gear 24 has the tenth rotary element, the eleventh rotary element, and the twelfth rotary element of the automatic transmission 20 which are arranged sequentially in accordance with the gear ratio λ4.

In the automatic transmission 20, the clutches C1 to C4 and the brakes B1 and B2 are engaged and disengaged as illustrated in FIG. 3 to change the relationship of connection of the first to twelfth rotary elements discussed above, which makes it possible to form nine power transfer paths in the forward rotational direction and one power transfer path in the reverse rotational direction from the input shaft 20i to the output shaft 20o, that is, establish first to ninth forward speeds and a reverse speed.

Specifically, the first forward speed is established by engaging the clutch C1 and the brakes B1 and B2 and disengaging the remaining clutches C2, C3, and C4. That is, to establish the first forward speed, the first sun gear 21s of the first planetary gear 21 and the fourth sun gear 24s of the fourth planetary gear 24 are connected to the input shaft 20i by the clutch C1; further, the second carrier 22c of the second planetary gear 22 and the third sun gear 23s of the third planetary gear 23 are held stationary to the transmission case 11 by the brake B1 so as to be unrotatable; and the third carrier 23c of the third planetary gear 23 is held stationary to the transmission case 11 by the brake B2 so as to be unrotatable. In the embodiment (in the case where the gear ratios of the first to fourth planetary gears 21 to 24 are determined as λ1=0.280, λ2=0.435, λ3=0.410, and λ4=0.460; the same applies hereinafter), a gear ratio γ1 of the first forward speed (the rotational speed of the input shaft 20i/the rotational speed of the output shaft 20o) is determined as γ1=4.571. Further, the torque distribution of each of the clutch C1 and the brakes B1 and B2 at the time when the first forward speed is established is as indicated in FIG. 3.

The second forward speed is established by engaging the clutches C1 and C2 and the brake B2 and disengaging the remaining clutches C3 and C4 and brake B1. That is, to establish the second forward speed, the first sun gear 21s of the first planetary gear 21 and the fourth sun gear 24s of the fourth planetary gear 24 are connected to the input shaft 20i by the clutch C1; the first ring gear 21r of the first planetary gear 21 and the third ring gear 23r of the third planetary gear 23 are each connected to the fourth carrier 24c of the fourth planetary gear 24 by the clutch C2; and further, the third carrier 23c of the third planetary gear 23 is held stationary to the transmission case 11 by the brake B2 so as to be unrotatable. In the embodiment, a gear ratio γ2 of the second forward speed is determined as γ2=2.895. In addition, the step ratio between the first forward speed and the second forward speed is determined as γ1/γ2=1.579. Further, the torque distribution of each of the clutches C1 and C2 and the brake B2 at the time when the second forward speed is established is as indicated in FIG. 3.

The third forward speed is established by engaging the clutches C1 and C2 and the brake B1 and disengaging the remaining clutches C3 and C4 and brake B2. That is, to establish the third forward speed, the first sun gear 21s of the first planetary gear 21 and the fourth sun gear 24s of the fourth planetary gear 24 are connected to the input shaft 20i by the clutch C1; the first ring gear 21r of the first planetary gear 21 and the third ring gear 23r of the third planetary gear 23 are each connected to the fourth carrier 24c of the fourth planetary gear 24 by the clutch C2; and further, the second carrier 22c of the second planetary gear 22 and the third sun gear 23s of the third planetary gear 23 are held stationary to the transmission case 11 by the brake B1 so as to be unrotatable. In the embodiment, a gear ratio γ3 of the third forward speed is determined as γ3=2.151. In addition, the step ratio between the second forward speed and the third forward speed is determined as γ2/γ3=1.346. Further, the torque distribution of each of the clutches C1 and C2 and the brake B1 at the time when the third forward speed is established is as indicated in FIG. 3.

The fourth forward speed is established by engaging the clutches C1 and C3 and the brake B1 and disengaging the remaining clutches C2 and C4 and brake B2. That is, to establish the fourth forward speed, the first sun gear 21s of the first planetary gear 21 and the fourth sun gear 24s of the fourth planetary gear 24 are connected to the input shaft 20i by the clutch C1; the third carrier 23c of the third planetary gear 23 and the fourth carrier 24c of the fourth planetary gear 24 are connected to each other by the clutch C3; and further, the second carrier 22c of the second planetary gear 22 and the third sun gear 23s of the third planetary gear 23 are held stationary to the transmission case 11 by the brake B1 so as to be unrotatable. In the embodiment, a gear ratio γ4 of the fourth forward speed is determined as γ4=1.767. In addition, the step ratio between the third forward speed and the fourth forward speed is determined as γ3/γ4=1.217. Further, the torque distribution of each of the clutches C1 and C3 and the brake B1 at the time when the fourth forward speed is established is as indicated in FIG. 3.

The fifth forward speed is established by engaging the clutches C1, C3, and C4 and disengaging the remaining clutch C2 and brakes B1 and B2. That is, to establish the fifth forward speed, the first sun gear 21s of the first planetary gear 21 and the fourth sun gear 24s of the fourth planetary gear 24 are connected to the input shaft 20i by the clutch C1; the third carrier 23c of the third planetary gear 23 and the fourth carrier 24c of the fourth planetary gear 24 are connected to each other by the clutch C3; and further, the fourth carrier 24c of the fourth planetary gear 24 is connected to the input shaft 20i by the clutch C4. In the embodiment, a gear ratio γ5 of the fifth forward speed is determined as γ5=1.327. In addition, the step ratio between the fourth forward speed and the fifth forward speed is determined as γ4/γ5=1.332. Further, the torque distribution of each of the clutches C1, C3, and C4 at the time when the fifth forward speed is established is as indicated in FIG. 3.

The sixth forward speed is established by engaging the clutches C1, C2, and C4 and disengaging the remaining clutch C3 and brakes B1 and B2. That is, to establish the sixth forward speed, the first sun gear 21s of the first planetary gear 21 and the fourth sun gear 24s of the fourth planetary gear 24 are connected to the input shaft 20i by the clutch C1; the first ring gear 21r of the first planetary gear 21 and the third ring gear 23r of the third planetary gear 23 are each connected to the fourth carrier 24c of the fourth planetary gear 24 by the clutch C2; and further, the fourth carrier 24c of the fourth planetary gear 24 is connected to the input shaft 20i by the clutch C4. In the embodiment, a gear ratio γ6 of the sixth forward speed is determined as γ6=1.000. In addition, the step ratio between the fifth forward speed and the sixth forward speed is determined as γ5/γ6=1.327. Further, the torque distribution of each of the clutches C1, C2, and C4 at the time when the sixth forward speed is established is as indicated in FIG. 3.

The seventh forward speed is established by engaging the clutches C2, C3, and C4 and disengaging the remaining clutch C1 and brakes B1 and B2. That is, to establish the seventh forward speed, the first ring gear 21r of the first planetary gear 21 and the third ring gear 23r of the third planetary gear 23 are each connected to the fourth carrier 24c of the fourth planetary gear 24 by the clutch C2; the third carrier 23c of the third planetary gear 23 and the fourth carrier 24c of the fourth planetary gear 24 are connected to each other by the clutch C3; and further, the fourth carrier 24c of the fourth planetary gear 24 is connected to the input shaft 20i by the clutch C4. In the embodiment, a gear ratio γ7 of the seventh forward speed is determined as γ7=0.829. In addition, the step ratio between the sixth forward speed and the seventh forward speed is determined as γ6/γ7=1.207. Further, the torque distribution of each of the clutches C2, C3, and C4 at the time when the seventh forward speed is established is as indicated in FIG. 3.

The eighth forward speed is established by engaging the clutches C2 and C4 and the brake B1 and disengaging the remaining clutches C1 and C3 and brake B2. That is, to establish the eighth forward speed, the first ring gear 21r of the first planetary gear 21 and the third ring gear 23r of the third planetary gear 23 are each connected to the fourth carrier 24c of the fourth planetary gear 24 by the clutch C2; the fourth carrier 24c of the fourth planetary gear 24 is connected to the input shaft 20i by the clutch C4; and further, the second carrier 22c of the second planetary gear 22 and the third sun gear 23s of the third planetary gear 23 are held stationary to the transmission case 11 by the brake B1 so as to be unrotatable. In the embodiment, a gear ratio γ8 of the eighth forward speed is determined as γ8=0.678. In addition, the step ratio between the seventh forward speed and the eighth forward speed is determined as γ7/γ8=1.223. Further, the torque distribution of each of the clutches C2 and C4 and the brake B1 at the time when the eighth forward speed is established is as indicated in FIG. 3.

The ninth forward speed is established by engaging the clutches C3 and C4 and the brake B1 and disengaging the remaining clutches C1 and C2 and brake B2. That is, to establish the ninth forward speed, the third carrier 23c of the third planetary gear 23 and the fourth carrier 24c of the fourth planetary gear 24 are connected to each other by the clutch C3; the fourth carrier 24c of the fourth planetary gear 24 is connected to the input shaft 20i by the clutch C4; and further, the second carrier 22c of the second planetary gear 22 and the third sun gear 23s of the third planetary gear 23 are held stationary to the transmission case 11 by the brake B1 so as to be unrotatable. In the embodiment, a gear ratio γ9 of the ninth forward speed is determined as γ9=0.557. In addition, the step ratio between the eighth forward speed and the ninth forward speed is determined as γ8/γ9=1.217. Further, the torque distribution of each of the clutches C3 and C4 and the brake B1 at the time when the ninth forward speed is established is as indicated in FIG. 3. The spread (gear ratio width=the gear ratio γ1 of the first forward speed as the lowest speed/the gear ratio γ9 of the ninth forward speed as the highest speed) of the automatic transmission 20 is determined as γ1/γ9=8.210.

The reverse speed is established by engaging the clutches C1 and C4 and the brake B2 and disengaging the remaining clutches C2 and C3 and brake B1. That is, to establish the reverse speed, the first sun gear 21s of the first planetary gear 21 and the fourth sun gear 24s of the fourth planetary gear 24 are connected to the input shaft 20i by the clutch C1; the fourth carrier 24c of the fourth planetary gear 24 is connected to the input shaft 20i by the clutch C4; and further, the third carrier 23c of the third planetary gear 23 is held stationary to the transmission case 11 by the brake B2 so as to be unrotatable. In the embodiment, a gear ratio γrev of the reverse speed is determined as γrev=−2.872. In addition, the step ratio between the first forward speed and the reverse speed is determined as |γrev/γ1|=0.628. Further, the torque distribution of each of the clutches C1 and C4 and the brake B1 at the time when the reverse speed is established is as indicated in FIG. 3.

As discussed above, with the automatic transmission 20, it is possible to provide the first to ninth forward speeds and the reverse speed by engaging and disengaging the clutches C1 to C4 and the brakes B1 and B2. As a result, with the automatic transmission 20, it is possible to improve the fuel efficiency of the vehicle, especially at a high vehicle speed, by further increasing the spread (in the embodiment, to 8.210), improve the acceleration performance with each shift speed by further making the speed ratios of lower speeds higher and further making the speed ratios of higher speeds lower, and improve the shifting feeling by optimizing the step ratios (suppressing an increase in step ratio). Thus, with the automatic transmission 20, it is possible to advantageously improve both the fuel efficiency etc. of the vehicle on which the automatic transmission 20 is mounted and the drivability, that is, the acceleration performance and the shifting feeling of the vehicle etc.

In the automatic transmission 20, in addition, the first forward speed to the ninth forward speed and the reverse speed can be established by engaging three of the six engagement elements, namely the clutches C1 to C4 and the brakes B1 and B2, and disengaging the remaining three engagement elements. Consequently, it is possible to reduce the number of engagement elements to be disengaged to establish a shift speed compared to a transmission in which a plurality of shift speeds are established by engaging two of six clutches and brakes and disengaging the remaining four clutches and brakes, for example. As a result, the power transfer efficiency of the automatic transmission 20, that is, the fuel efficiency of the vehicle, can be further improved by reducing a drag loss due to slight contact between members in the engagement elements disengaged to establish a shift speed.

With the automatic transmission 20, further, as illustrated in FIG. 3, the torque distribution of each of the clutches C1 to C4 can be lowered to approximately 1.9 times or less. Thus, it is possible to make the entire device lightweight and compact by reducing the axial length or outside diameter of each of the clutches C1 to C4, and to suppress degradation in drag loss in the clutches C1 to C4. With the automatic transmission 20, in addition, the torque distribution ratios (largest value/smallest value of torque distribution) of the clutches C1 to C4 and the brakes B1 and B2 can be lowered to approximately 8 times or less. Thus, it is possible to easily and immediately change the supply amount and the supply speed of working oil when the torque capacity required for each of the clutches C1 to C4 and the brakes B1 and B2 is varied significantly, which further improves the hydraulic controllability of the clutches C1 to C4 and the brakes B1 and B2. As a result, with the automatic transmission 20, it is possible to improve the speed change performance, and to make the entire device lightweight and compact.

In addition, with the first, third, and fourth planetary gears 21, 23, and 24 each constituted as a single-pinion planetary gear, it is possible to further improve the power transfer efficiency of the automatic transmission 20, that is, the fuel efficiency of the vehicle, by reducing a meshing loss between rotary elements of the first, third, and fourth planetary gears 21, 23, and 24 compared to a case where the first, third, and fourth planetary gears 21, 23, and 24 are each constituted as a double-pinion planetary gear, for example, and to improve the assemblability while suppressing an increase in weight of the automatic transmission 20 by reducing the number of parts.

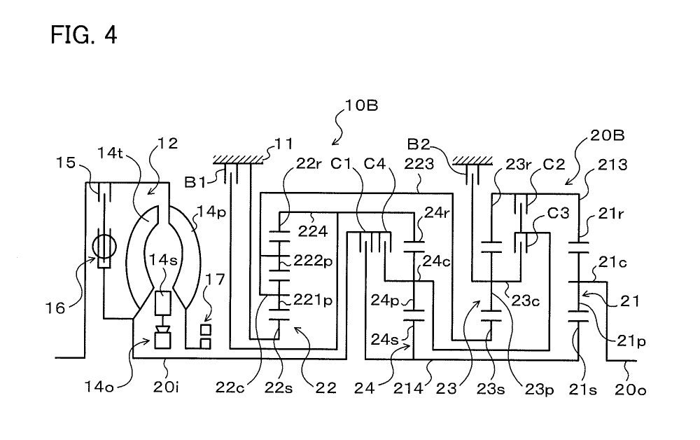

In the automatic transmission 20, the brake B1 is engaged to establish the first, third, fourth, eighth, and ninth forward speeds to stop rotation of all the three rotary elements of the second planetary gear 22, namely the second sun gear 22s, the second ring gear 22r, and the second carrier 22c (make the rotary elements stationary). Thus, the brake B1 may hold (connect) the second ring gear 22r (fifth rotary element), which serves as a fixable element of the second planetary gear 22 in place of the second carrier 22c (sixth engagement element), stationary to the transmission case 11, which serves as a stationary member, such that the second ring gear 22r is unrotatable, and releases the second ring gear 22r held stationary from the transmission case 11 such that the second ring gear 22r is rotatable as the brake B1 included in an automatic transmission 20B of a power transfer device 10B illustrated in FIG. 4.

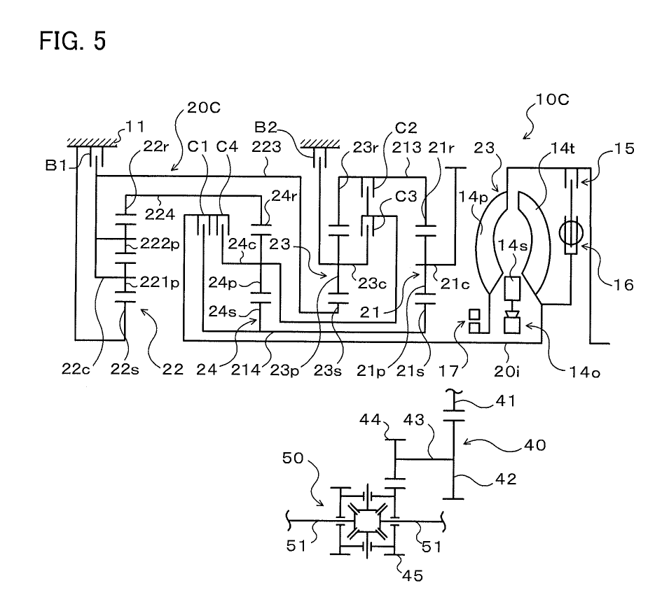

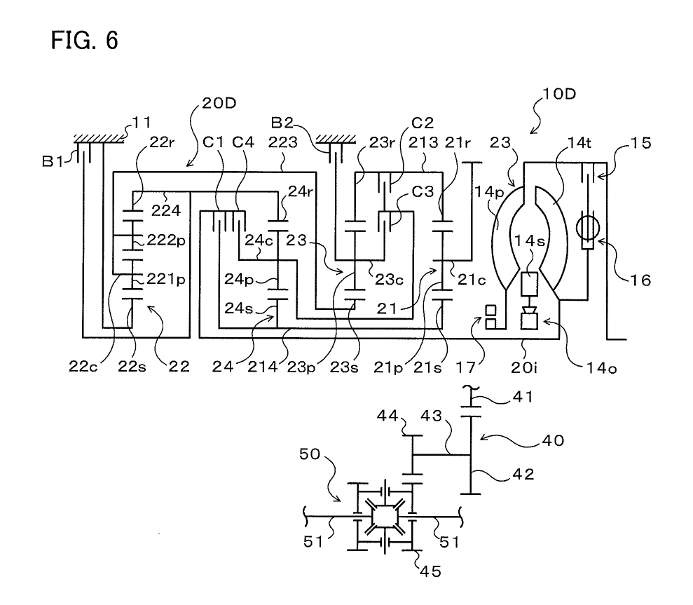

FIG. 5 illustrates a schematic configuration of a power transfer device 10C that includes an automatic transmission 20C that serves as a multi-speed transmission according to still another embodiment. The power transfer device 10C illustrated in the drawing is connected to a crankshaft of an engine (internal combustion engine; not illustrated) transversely mounted in the front portion of a front-drive vehicle, and can transfer power (torque) from the engine to left and right front wheels (drive wheels; not illustrated). The automatic transmission 20C of the power transfer device 10C corresponds to the automatic transmission 20 discussed above which has been modified for use in a front-drive vehicle. In addition, FIG. 6 illustrates a power transfer device 10D that includes an automatic transmission 20D that serves as a multi-speed transmission according to another embodiment. The power transfer device 10D illustrated in the drawing is also connected to a crankshaft of an engine (internal combustion engine; not illustrated) transversely mounted in the front portion of a front-drive vehicle, and can transfer power (torque) from the engine to left and right front wheels (drive wheels; not illustrated). The automatic transmission 20D of the power transfer device 10D corresponds to the automatic transmission 20B discussed above which has been modified for use in a front-drive vehicle.

In the automatic transmissions 20C and 20D, the first carrier 21c of the first planetary gear 21 is always coupled to a counter drive gear 41 that serves as an output member. Power (torque) transferred from the automatic transmission 20C, 20D to the counter drive gear 41 which serves as an output member is transferred to the left and right front wheels via a gear train 40 that includes, in addition to the counter drive gear 41, a counter driven gear 42 meshed with the counter drive gear 41, a drive pinion gear (final drive gear) 44 coupled to the counter driven gear 42 via a counter shaft 43, and a differential ring gear (final driven gear) 45 meshed with the drive pinion gear 44, a differential gear 50 coupled to the differential ring gear 45, and a drive shaft 51. In this way, the multi-speed transmission according to a preferred embodiment may also be constituted as a transmission to be mounted on a front-drive vehicle.

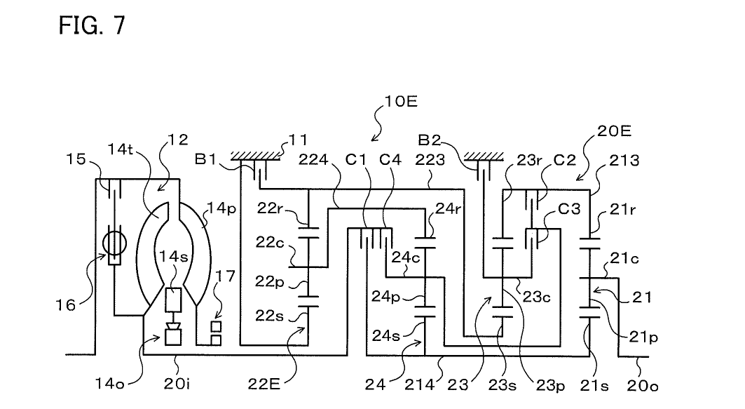

FIG. 7 illustrates a schematic configuration of a power transfer device 10E that includes an automatic transmission 20E that serves as a multi-speed transmission according to still another embodiment.

The automatic transmission E illustrated in FIG. 7 corresponds to the automatic transmission 20 discussed above in which the double-pinion second planetary gear 22 has been replaced with a single-pinion second planetary gear 22E. That is, the second planetary gear 22E has: a second sun gear 22s which is an externally toothed gear; a second ring gear 22r which is an internally toothed gear disposed concentrically with the second sun gear 22s; a plurality of second pinion gears 22p meshed with the second sun gear 22s and the second ring gear 22r; and a second carrier 22c that rotatably (turnably) and revolvably holds the plurality of second pinion gears 22p. A gear ratio λ2 of the second planetary gear 22E (the number of teeth of the second sun gear 22s/the number of teeth of the second ring gear 22r) is determined as λ2=0.520, for example.

In addition, the first, third, and fourth planetary gears 21, 23, and 24 of the automatic transmission 20E are single-pinion planetary gears that are similar to those of the automatic transmission 20 or the like. A gear ratio λ1 of the first planetary gear 21 (the number of teeth of the first sun gear 21s/the number of teeth of the first ring gear 21r) is determined as λ1=0.280, for example. In addition, a gear ratio λ3 of the third planetary gear 23 (the number of teeth of the third sun gear 23s/the number of teeth of the third ring gear 23r) is determined as λ3=0.420, for example. Further, a gear ratio λ4 of the fourth planetary gear 24 (the number of teeth of the fourth sun gear 24s/the number of teeth of the fourth ring gear 24r) is determined as λ4=0.510, for example.

As illustrated in FIG. 7, the second sun gear 22s of the second planetary gear 22 is always connected (fixed) to the transmission case 11 which serves as a stationary member, and always stationary. In addition, the second ring gear 22r of the second planetary gear 22 is always coupled to the third sun gear 23s of the third planetary gear 23 via a coupling member (third coupling element) 223, and always rotated and stopped together (and coaxially) with the third sun gear 23s. Further, the second carrier 22c of the second planetary gear 22 is always coupled to the fourth ring gear 24r of the fourth planetary gear 24 via a coupling member (fourth coupling element) 224, and always rotated and stopped together (and coaxially) with the fourth ring gear 24r. In addition, the brake B2 holds (connects) the ring gear (second ring gear) of the second planetary gear 22 and the third sun gear 23s of the third planetary gear 23, which are always coupled to each other, to the transmission case 11 such that the second ring gear and the third sun gear 23s are unrotatable, and releases the second ring gear and the third sun gear 23s held stationary from the transmission case 11 serving as the stationary member such that the second ring gear and the third sun gear 23s are rotatable.

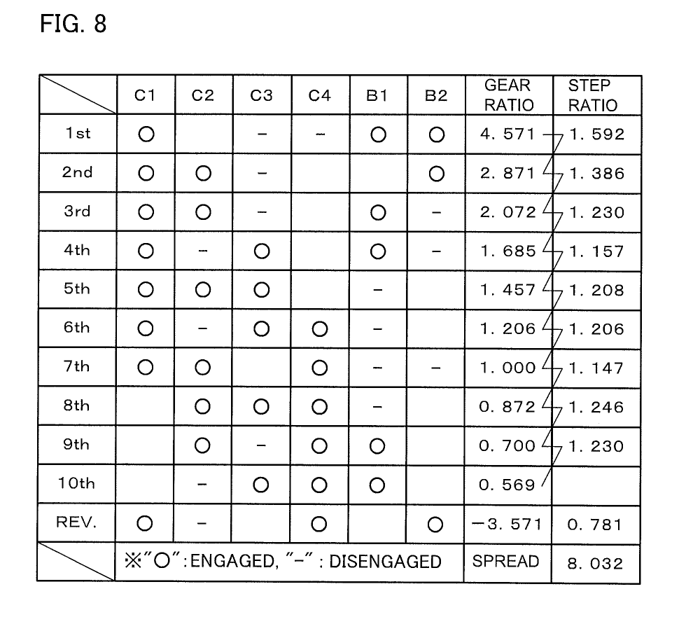

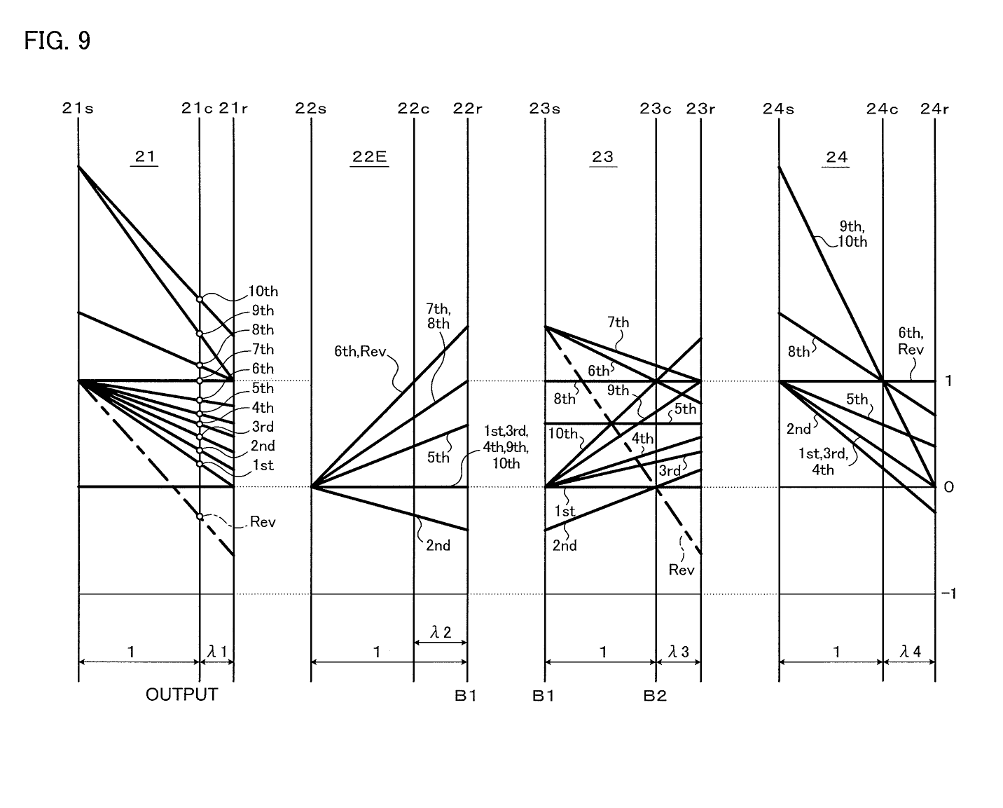

FIG. 8 is an operation table illustrating the relationship between shift speeds of the automatic transmission 20E and the respective operating states of the clutches C1 to C4 and the brakes B1 and B2. FIG. 9 is a velocity diagram illustrating the ratio of the rotational speed of each rotary element to the rotational speed of the input shaft 20i (input rotational speed) of the automatic transmission 20E. The automatic transmission 20E provides first to tenth forward speeds and a reverse speed as illustrated in FIG. 9 by selectively engaging three of the clutches C1 to C4 and the brakes B1 and B2 as illustrated in FIG. 8. Consequently, also with the automatic transmission 20E, it is possible to further improve the fuel efficiency, the drivability, and the speed change performance of a vehicle on which the automatic transmission 20E is mounted, and to make the entire device lightweight and compact. Further, with all the first to fourth planetary gears 21, 22E, 23, and 24 constituted as a single-pinion planetary gear, it is possible to further improve the power transfer efficiency of the automatic transmission 20E, that is, the fuel efficiency of the vehicle, by reducing a meshing loss between rotary elements of the first to fourth planetary gears 21, 22E, 23, and 24, and to improve the assemblability while suppressing an increase in weight of the automatic transmission 20E by reducing the number of parts.

In the automatic transmissions 20 to 20E discussed above, at least one of the clutches C1 to C4 and the brakes B1 and B2 may be a meshing engagement element such as a dog clutch or a dog brake. For example, in the automatic transmissions 20 to 20E, a dog clutch or a dog brake may be adopted as the clutch C1 which is engaged continuously to establish the first to sixth forward speeds, the clutch C4 which is engaged continuously to establish the fifth to ninth forward speeds, and the brake B2 which is engaged continuously to establish the first and second forward speeds and engaged to establish the reverse speed. In the automatic transmissions 20, 20B, and 20E, in addition, the gear ratios λ1 to λ4 used in the first to fourth planetary gears 21 to 24 etc. are not limited to those described above. In the automatic transmissions 20 to 20E, further, at least one of the first, third, and fourth planetary gears 21, 23, and 24 may be a double-pinion planetary gear. Also in the automatic transmissions 20B, 20C, and 20D, in addition, the double-pinion second planetary gear 22 may be replaced with a single-pinion second planetary gear to adopt gear ratios that are the same as those used in the automatic transmission 20E.

As has been described above, a preferred embodiment provides a multi-speed transmission that changes a speed of power transferred to an input member to transfer the power to an output member, including: a first planetary gear that has a first rotary element, a second rotary element, and a third rotary element that are arranged sequentially in accordance with a gear ratio; a second planetary gear that has a fourth rotary element, a fifth rotary element, and a sixth rotary element that are arranged sequentially in accordance with a gear ratio; a third planetary gear that has a seventh rotary element, an eighth rotary element, and a ninth rotary element that are arranged sequentially in accordance with a gear ratio; a fourth planetary gear that has a tenth rotary element, an eleventh rotary element, and a twelfth rotary element that are arranged sequentially in accordance with a gear ratio; and first, second, third, fourth, fifth, and sixth engagement elements that connect and disconnect one of the rotary elements of the first, second, third, and fourth planetary gears to and from another rotary element or a stationary member, in which: the second rotary element of the first planetary gear is always coupled to the output member; the first rotary element of the first planetary gear and the tenth rotary element of the fourth planetary gear are always coupled to each other; the third rotary element of the first planetary gear and the ninth rotary element of the third planetary gear are always coupled to each other; the fourth rotary element of the second planetary gear is always coupled to the stationary member; the fifth rotary element of the second planetary gear and the twelfth rotary element of the fourth planetary gear are always coupled to each other; the sixth rotary element of the second planetary gear and the seventh rotary element of the third planetary gear are always coupled to each other; the first engagement element connects and disconnects the first rotary element of the first planetary gear and the tenth rotary element of the fourth planetary gear, which are always coupled to each other, and the input member to and from each other; the second engagement element connects and disconnects the third rotary element of the first planetary gear and the ninth rotary element of the third planetary gear, which are always coupled to each other, and the eleventh rotary element of the fourth planetary gear to and from each other; the third engagement element connects and disconnects the eighth rotary element of the third planetary gear and the eleventh rotary element of the fourth planetary gear to and from each other; the fourth engagement element connects and disconnects the eleventh rotary element of the fourth planetary gear and the input member to and from each other; the fifth engagement element connects the fifth rotary element or the sixth rotary element of the second planetary gear to the stationary member to unrotatably hold the fifth rotary element or the sixth rotary element, and disconnects the fifth rotary element or the sixth rotary element and the stationary member from each other; and the sixth engagement element connects the eighth rotary element of the third planetary gear to the stationary member to unrotatably hold the eighth rotary element, and disconnects the eighth rotary element and the stationary member from each other.

With the thus configured multi-speed transmission, first to ninth forward speeds, or first to tenth forward speeds, and a reverse speed can be established by selectively engaging three of the first, second, third, fourth, fifth, and sixth engagement elements. Consequently, it is possible to improve the fuel efficiency of the vehicle on which the multi-speed transmission is mounted by increasing the spread, and to further improve the drivability, that is, the acceleration performance of the vehicle etc., by making the speed ratios of lower speeds higher and making the speed ratios of higher speeds lower. With the multi-speed transmission, in addition, the torque distribution of each of the first to fourth engagement elements can be reduced to make the first to fourth engagement elements lightweight and compact, and to suppress degradation in drag loss in the first to fourth engagement elements. Further, it is possible to improve the controllability of the first to sixth engagement elements by making the torque distribution ratios of the first to sixth engagement elements lower. Thus, with the multi-speed transmission according to a preferred embodiment, it is possible to further improve the fuel efficiency, the drivability, and the speed change performance of the vehicle on which the multi-speed transmission is mounted, and to make the entire device lightweight and compact.

In the multi-speed transmission according to a preferred embodiment, in addition, first to ninth forward speeds and a reverse speed can be established by engaging the first to sixth engagement elements as follows. That is, the first forward speed is established by engaging the first engagement element, the fifth engagement element, and the sixth engagement element. The second forward speed is established by engaging the first engagement element, the second engagement element, and the sixth engagement element. The third forward speed is established by engaging the first engagement element, the second engagement element, and the fifth engagement element. The fourth forward speed is established by engaging the first engagement element, the third engagement element, and the fifth engagement element. The fifth forward speed is established by engaging the first engagement element, the third engagement element, and the fourth engagement element. The sixth forward speed is established by engaging the first engagement element, the second engagement element, and the fourth engagement element. The seventh forward speed is established by engaging the second engagement element, the third engagement element, and the fourth engagement element. The eighth forward speed is established by engaging the second engagement element, the fourth engagement element, and the fifth engagement element. The ninth forward speed is established by engaging the third engagement element, the fourth engagement element, and the fifth engagement element. The reverse speed is established by engaging the first engagement element, the fourth engagement element, and the sixth engagement element.

Consequently, it is possible to reduce the number of engagement elements to be disengaged to establish a shift speed compared to a transmission in which a plurality of shift speeds are established by engaging two of six engagement elements and disengaging the remaining four engagement elements, for example. As a result, the power transfer efficiency of the multi-speed transmission, that is, the fuel efficiency of the vehicle, can be further improved by reducing a drag loss in the engagement elements disengaged to establish a shift speed.

The first planetary gear may be a single-pinion planetary gear that has a first sun gear, a first ring gear, and a first carrier that rotatably and revolvably holds a plurality of first pinion gears meshed with the first sun gear and the first ring gear; the second planetary gear may be a double-pinion planetary gear that has a second sun gear, a second ring gear, and a second carrier that rotatably and revolvably holds two sets of pinion gears meshed with each other with one set of pinion gears meshed with the second sun gear and with the other set of pinion gears meshed with the second ring gear; the third planetary gear may be a single-pinion planetary gear that has a third sun gear, a third ring gear, and a third carrier that rotatably and revolvably holds a plurality of third pinion gears meshed with the third sun gear and the third ring gear; the fourth planetary gear may be a single-pinion planetary gear that has a fourth sun gear, a fourth ring gear, and a fourth carrier that rotatably and revolvably holds a plurality of fourth pinion gears meshed with the fourth sun gear and the fourth ring gear; the first rotary element may be the first sun gear, the second rotary element may be the first carrier, and the third rotary element may be the first ring gear; the fourth rotary element may be the second sun gear, the fifth rotary element may be the second ring gear, and the sixth rotary element may be the second carrier; the seventh rotary element may be the third sun gear, the eighth rotary element may be the third carrier, and the ninth rotary element may be the third ring gear; and the tenth rotary element may be the fourth sun gear, the eleventh rotary element may be the fourth carrier, and the twelfth rotary element may be the fourth ring gear.

In this way, with the first, third, and fourth planetary gears each constituted as a single-pinion planetary gear, it is possible to further improve the power transfer efficiency of the multi-speed transmission, that is, the fuel efficiency of the vehicle, by reducing a meshing loss between rotary elements of the first, third, and fourth planetary gears, and to improve the assemblability while suppressing an increase in weight of the multi-speed transmission by reducing the number of parts.

In the multi-speed transmission according to a preferred embodiment, further, first to tenth forward speeds and a reverse speed can be established by engaging the first to sixth engagement elements as follows. That is, the first forward speed is established by engaging the first engagement element, the fifth engagement element, and the sixth engagement element. The second forward speed is established by engaging the first engagement element, the second engagement element, and the sixth engagement element. The third forward speed is established by engaging the first engagement element, the second engagement element, and the fifth engagement element. The fourth forward speed is established by engaging the first engagement element, the third engagement element, and the fifth engagement element. The fifth forward speed is established by engaging the first engagement element, the second engagement element, and the third engagement element. The sixth forward speed is established by engaging the first engagement element, the third engagement element, and the fourth engagement element. The seventh forward speed is established by engaging the first engagement element, the second engagement element, and the fourth engagement element. The eighth forward speed is established by engaging the second engagement element, the third engagement element, and the fourth engagement element. The ninth forward speed is established by engaging the second engagement element, the fourth engagement element, and the fifth engagement element. The tenth forward speed is established by engaging the third engagement element, the fourth engagement element, and the fifth engagement element. The reverse speed is established by engaging the first engagement element, the fourth engagement element, and the sixth engagement element.

Consequently, it is possible to reduce the number of engagement elements to be disengaged to establish a shift speed compared to a transmission in which a plurality of shift speeds are established by engaging two of six engagement elements and disengaging the remaining four engagement elements, for example. As a result, the power transfer efficiency of the multi-speed transmission, that is, the fuel efficiency of the vehicle, can be further improved by reducing a drag loss in the engagement elements disengaged to establish a shift speed.

The first planetary gear may be a single-pinion planetary gear that has a first sun gear, a first ring gear, and a first carrier that rotatably and revolvably holds a plurality of first pinion gears meshed with the first sun gear and the first ring gear; the second planetary gear may be a single-pinion planetary gear that has a second sun gear, a second ring gear, and a second carrier that rotatably and revolvably holds a plurality of second pinion gears meshed with the second sun gear and the second ring gear; the third planetary gear may be a single-pinion planetary gear that has a third sun gear, a third ring gear, and a third carrier that rotatably and revolvably holds a plurality of third pinion gears meshed with the third sun gear and the third ring gear; the fourth planetary gear may be a single-pinion planetary gear that has a fourth sun gear, a fourth ring gear, and a fourth carrier that rotatably and revolvably holds a plurality of fourth pinion gears meshed with the fourth sun gear and the fourth ring gear; the first rotary element may be the first sun gear, the second rotary element may be the first carrier, and the third rotary element may be the first ring gear; the fourth rotary element may be the second sun gear, the fifth rotary element may be the second carrier, and the sixth rotary element may be the second ring gear; the seventh rotary element may be the third sun gear, the eighth rotary element may be the third carrier, and the ninth rotary element may be the third ring gear; and the tenth rotary element may be the fourth sun gear, the eleventh rotary element may be the fourth carrier, and the twelfth rotary element may be the fourth ring gear.

In this way, with all the first to fourth planetary gears constituted as a single-pinion planetary gear, it is possible to further improve the power transfer efficiency of the multi-speed transmission, that is, the fuel efficiency of the vehicle, by reducing a meshing loss between rotary elements of the first to fourth planetary gears, and to improve the assemblability while suppressing an increase in weight of the multi-speed transmission by reducing the number of parts.

The output member may be an output shaft coupled to rear wheels of a vehicle via a differential gear. That is, the multi-speed transmission according to a preferred embodiment may be constituted as a transmission to be mounted on a rear-drive vehicle.

The output member may be a counter drive gear included in a gear train that transfers power to a differential gear coupled to front wheels of a vehicle. That is, the multi-speed transmission according to some preferred embodiments may be constituted as a transmission to be mounted on a front-drive vehicle.

The present invention is not limited to the embodiments described above in any way, and it is a matter of course that the present invention may be modified in various ways without departing from the scope of the present invention. Further, the mode for carrying out the present invention described above is merely a specific form of the invention described in the “SUMMARY” section, and does not limit the elements of the invention described in the “SUMMARY” section.

1-7. (canceled)

8. A multi-speed transmission that changes a speed of power transferred to an input member to transfer the power to an output member, comprising:
a first planetary gear that has a first rotary element, a second rotary element, and a third rotary element that are arranged sequentially in accordance with a gear ratio;
a second planetary gear that has a fourth rotary element, a fifth rotary element, and a sixth rotary element that are arranged sequentially in accordance with a gear ratio;
a third planetary gear that has a seventh rotary element, an eighth rotary element, and a ninth rotary element that are arranged sequentially in accordance with a gear ratio;
a fourth planetary gear that has a tenth rotary element, an eleventh rotary element, and a twelfth rotary element that are arranged sequentially in accordance with a gear ratio; and
first, second, third, fourth, fifth, and sixth engagement elements that connect and disconnect one of the rotary elements of the first, second, third, and fourth planetary gears to and from another rotary element or a stationary member, wherein:
the second rotary element of the first planetary gear is always coupled to the output member;
the first rotary element of the first planetary gear and the tenth rotary element of the fourth planetary gear are always coupled to each other;
the third rotary element of the first planetary gear and the ninth rotary element of the third planetary gear are always coupled to each other;
the fourth rotary element of the second planetary gear is always coupled to the stationary member;
the fifth rotary element of the second planetary gear and the twelfth rotary element of the fourth planetary gear are always coupled to each other;
the sixth rotary element of the second planetary gear and the seventh rotary element of the third planetary gear are always coupled to each other;
the first engagement element connects and disconnects the first rotary element of the first planetary gear and the tenth rotary element of the fourth planetary gear, which are always coupled to each other, and the input member to and from each other;
the second engagement element connects and disconnects the third rotary element of the first planetary gear and the ninth rotary element of the third planetary gear, which are always coupled to each other, and the eleventh rotary element of the fourth planetary gear to and from each other;
the third engagement element connects and disconnects the eighth rotary element of the third planetary gear and the eleventh rotary element of the fourth planetary gear to and from each other;
the fourth engagement element connects and disconnects the eleventh rotary element of the fourth planetary gear and the input member to and from each other;
the fifth engagement element connects the fifth rotary element or the sixth rotary element of the second planetary gear to the stationary member to unrotatably hold the fifth rotary element or the sixth rotary element, and disconnects the fifth rotary element or the sixth rotary element and the stationary member from each other; and
the sixth engagement element connects the eighth rotary element of the third planetary gear to the stationary member to unrotatably hold the eighth rotary element, and disconnects the eighth rotary element and the stationary member from each other.

9. The multi-speed transmission according to claim 8, wherein:
a first forward speed is established by engaging the first engagement element, the fifth engagement element, and the sixth engagement element;
a second forward speed is established by engaging the first engagement element, the second engagement element, and the sixth engagement element;
a third forward speed is established by engaging the first engagement element, the second engagement element, and the fifth engagement element;
a fourth forward speed is established by engaging the first engagement element, the third engagement element, and the fifth engagement element;
a fifth forward speed is established by engaging the first engagement element, the third engagement element, and the fourth engagement element;
a sixth forward speed is established by engaging the first engagement element, the second engagement element, and the fourth engagement element;
a seventh forward speed is established by engaging the second engagement element, the third engagement element, and the fourth engagement element;
an eighth forward speed is established by engaging the second engagement element, the fourth engagement element, and the fifth engagement element;
a ninth forward speed is established by engaging the third engagement element, the fourth engagement element, and the fifth engagement element; and
a reverse speed is established by engaging the first engagement element, the fourth engagement element, and the sixth engagement element.

10. The multi-speed transmission according to claim 9, wherein:
the first planetary gear is a single-pinion planetary gear that has a first sun gear, a first ring gear, and a first carrier that rotatably and revolvably holds a plurality of first pinion gears meshed with the first sun gear and the first ring gear;
the second planetary gear is a double-pinion planetary gear that has a second sun gear, a second ring gear, and a second carrier that rotatably and revolvably holds a plurality of sets of two pinion gears meshed with each other with one of the pinion gears meshed with the second sun gear and with the other one of the pinion gears meshed with the second ring gear;
the third planetary gear is a single-pinion planetary gear that has a third sun gear, a third ring gear, and a third carrier that rotatably and revolvably holds a plurality of third pinion gears meshed with the third sun gear and the third ring gear;
the fourth planetary gear is a single-pinion planetary gear that has a fourth sun gear, a fourth ring gear, and a fourth carrier that rotatably and revolvably holds a plurality of fourth pinion gears meshed with the fourth sun gear and the fourth ring gear;
the first rotary element is the first sun gear, the second rotary element is the first carrier, and the third rotary element is the first ring gear;
the fourth rotary element is the second sun gear, the fifth rotary element is the second ring gear, and the sixth rotary element is the second carrier;
the seventh rotary element is the third sun gear, the eighth rotary element is the third carrier, and the ninth rotary element is the third ring gear; and
the tenth rotary element is the fourth sun gear, the eleventh rotary element is the fourth carrier, and the twelfth rotary element is the fourth ring gear.

11. The multi-speed transmission according to claim 8, wherein:
the first planetary gear is a single-pinion planetary gear that has a first sun gear, a first ring gear, and a first carrier that rotatably and revolvably holds a plurality of first pinion gears meshed with the first sun gear and the first ring gear;
the second planetary gear is a double-pinion planetary gear that has a second sun gear, a second ring gear, and a second carrier that rotatably and revolvably holds two sets of pinion gears meshed with each other with one set of pinion gears meshed with the second sun gear and with the other set of pinion gears meshed with the second ring gear;
the third planetary gear is a single-pinion planetary gear that has a third sun gear, a third ring gear, and a third carrier that rotatably and revolvably holds a plurality of third pinion gears meshed with the third sun gear and the third ring gear;
the fourth planetary gear is a single-pinion planetary gear that has a fourth sun gear, a fourth ring gear, and a fourth carrier that rotatably and revolvably holds a plurality of fourth pinion gears meshed with the fourth sun gear and the fourth ring gear;
the first rotary element is the first sun gear, the second rotary element is the first carrier, and the third rotary element is the first ring gear;
the fourth rotary element is the second sun gear, the fifth rotary element is the second ring gear, and the sixth rotary element is the second carrier;
the seventh rotary element is the third sun gear, the eighth rotary element is the third carrier, and the ninth rotary element is the third ring gear; and
the tenth rotary element is the fourth sun gear, the eleventh rotary element is the fourth carrier, and the twelfth rotary element is the fourth ring gear.

12. The multi-speed transmission according to claim 8, wherein:
a first forward speed is established by engaging the first engagement element, the fifth engagement element, and the sixth engagement element;
a second forward speed is established by engaging the first engagement element, the second engagement element, and the sixth engagement element;
a third forward speed is established by engaging the first engagement element, the second engagement element, and the fifth engagement element;
a fourth forward speed is established by engaging the first engagement element, the third engagement element, and the fifth engagement element;
a fifth forward speed is established by engaging the first engagement element, the second engagement element, and the third engagement element;
a sixth forward speed is established by engaging the first engagement element, the third engagement element, and the fourth engagement element;
a seventh forward speed is established by engaging the first engagement element, the second engagement element, and the fourth engagement element;
an eighth forward speed is established by engaging the second engagement element, the third engagement element, and the fourth engagement element;
a ninth forward speed is established by engaging the second engagement element, the fourth engagement element, and the fifth engagement element;
a tenth forward speed is established by engaging the third engagement element, the fourth engagement element, and the fifth engagement element; and
a reverse speed is established by engaging the first engagement element, the fourth engagement element, and the sixth engagement element.

13. The multi-speed transmission according to claim 12, wherein:
the first planetary gear is a single-pinion planetary gear that has a first sun gear, a first ring gear, and a first carrier that rotatably and revolvably holds a plurality of first pinion gears meshed with the first sun gear and the first ring gear;
the second planetary gear is a single-pinion planetary gear that has a second sun gear, a second ring gear, and a second carrier that rotatably and revolvably holds a plurality of second pinion gears meshed with the second sun gear and the second ring gear;
the third planetary gear is a single-pinion planetary gear that has a third sun gear, a third ring gear, and a third carrier that rotatably and revolvably holds a plurality of third pinion gears meshed with the third sun gear and the third ring gear;
the fourth planetary gear is a single-pinion planetary gear that has a fourth sun gear, a fourth ring gear, and a fourth carrier that rotatably and revolvably holds a plurality of fourth pinion gears meshed with the fourth sun gear and the fourth ring gear;
the first rotary element is the first sun gear, the second rotary element is the first carrier, and the third rotary element is the first ring gear;
the fourth rotary element is the second sun gear, the fifth rotary element is the second carrier, and the sixth rotary element is the second ring gear;
the seventh rotary element is the third sun gear, the eighth rotary element is the third carrier, and the ninth rotary element is the third ring gear; and
the tenth rotary element is the fourth sun gear, the eleventh rotary element is the fourth carrier, and the twelfth rotary element is the fourth ring gear.

14. The multi-speed transmission according to claim 8, wherein:
the first planetary gear is a single-pinion planetary gear that has a first sun gear, a first ring gear, and a first carrier that rotatably and revolvably holds a plurality of first pinion gears meshed with the first sun gear and the first ring gear;
the second planetary gear is a single-pinion planetary gear that has a second sun gear, a second ring gear, and a second carrier that rotatably and revolvably holds a plurality of second pinion gears meshed with the second sun gear and the second ring gear;
the third planetary gear is a single-pinion planetary gear that has a third sun gear, a third ring gear, and a third carrier that rotatably and revolvably holds a plurality of third pinion gears meshed with the third sun gear and the third ring gear;
the fourth planetary gear is a single-pinion planetary gear that has a fourth sun gear, a fourth ring gear, and a fourth carrier that rotatably and revolvably holds a plurality of fourth pinion gears meshed with the fourth sun gear and the fourth ring gear;
the first rotary element is the first sun gear, the second rotary element is the first carrier, and the third rotary element is the first ring gear;
the fourth rotary element is the second sun gear, the fifth rotary element is the second carrier, and the sixth rotary element is the second ring gear;
the seventh rotary element is the third sun gear, the eighth rotary element is the third carrier, and the ninth rotary element is the third ring gear; and
the tenth rotary element is the fourth sun gear, the eleventh rotary element is the fourth carrier, and the twelfth rotary element is the fourth ring gear.

15. The multi-speed transmission according to claim 8, wherein
the output member is an output shaft coupled to rear wheels of a vehicle via a differential gear.

16. The multi-speed transmission according to claim 8, wherein
the output member is a counter drive gear included in a gear train that transfers power to a differential gear coupled to front wheels of a vehicle.
